(19) United States
(12) Patent Application Publication
(10) Pub. No.: US 2009/0001700 A1
(43) Pub. Date: Jan. 1, 2009

(54) Airbag housing

(75) Inventor: Norbert Sahm, Aschaffenburg (DE)

Correspondence Address: FOLEY AND LARDNER LLP;SUITE 500, 3000 K STREET NW, WASHINGTON, DC, 20007, US

(73) Assignee: Takata-Petri AG

(21) Appl. No.: 12/216,468

(22) Filed: Jul. 3, 2008

Related U.S. Application Data
(63) Continuation of application No. PCT/EP2006/012636, filed on Dec. 20, 2006.

(30) Foreign Application Priority Data
Jan. 5, 2006 (DE) 20 2006 000 300.2

(51) Int. Cl. B60R 21/16

(52) U.S. Cl. 280/743.1

(57) ABSTRACT

An airbag housing for a front seat passenger airbag module includes high side walls having a curved profile when viewed from above.

### CROSS-REFERENCE TO RELATED PATENT APPLICATIONS

This application is a Continuation of International Application PCT/EP2006/012636, filed Dec. 20, 2006, which was published in German as WO 2007/077030 and is incorporated herein by reference in its entirety.

### BACKGROUND

The present invention relates generally to the field of an airbag housing.

When an airbag is triggered, airbag housings are exposed to high pressure loads. The high pressure loads may lead to deformation of the housings. More particularly, the high pressure loads can lead to deformation of the housings of front seat passenger airbags that generally include high side walls. To fully utilize the rectangular construction of dashboards, the housings of front seat passenger airbag modules may be rectangular when viewed from above. To minimize deformation of the airbag housing, a stiffening method may be provided on the housing. Additionally, the airbag housing and the stiffening method may be reduced in size to reduce the folding space required for the airbag. Conventionally, multiple stiffening ribs are provided on the outside of the airbag housing to achieve the necessary stiffness of the housing walls. As a result, the airbag housing requires additional material and weighs more. Additionally, the corners of the airbag housing can be rounded to further optimize strength.

### SUMMARY

One embodiment of the invention relates to an airbag housing for a front seat passenger airbag module including high side walls having a curved profile when viewed from above.

### BRIEF DESCRIPTION OF THE DRAWINGS

The invention will be explained in more detail with reference to the illustrative drawings.

FIG. 1 is a top view of an airbag housing for a front seat passenger airbag, according to an exemplary embodiment.

FIG. 2 shows an airbag housing with a stiffening apparatus, according to an exemplary embodiment.

FIG. 3 shows a top view of an airbag housing for a front seat passenger airbag, according to an exemplary embodiment.

### DETAILED DESCRIPTION

According to various exemplary embodiments, an airbag housing may have a folding space volume that is similar to a conventional stiffened airbag housing, but include less material.

In a front seat passenger airbag module including high side walls, the side walls include a curved profile when viewed from above. The curved walls may require fewer stiffening apparatus, thereby saving on material in addition to lowering cost and weight.

In an exemplary embodiment, two inwardly curved longitudinal walls and two outwardly curved end walls may be provided as the side walls. The side walls may be designed as segments of a circle.

According to an exemplary embodiment, sections of the side walls may be curved inward and outward in an alternating manner.

A stiffening method may be included on the outside of the longitudinal walls, thereby increasing strength. A stiffening apparatus may run in a longitudinal direction of the airbag housing to stiffen each longitudinal wall. At least one stiffening rib may be included between the stiffening apparatus and the longitudinal wall. Furthermore, the stiffening method may employ fewer stiffening ribs than a conventional airbag housing. Additionally, one stiffening rib may be included in the center of each longitudinal wall.

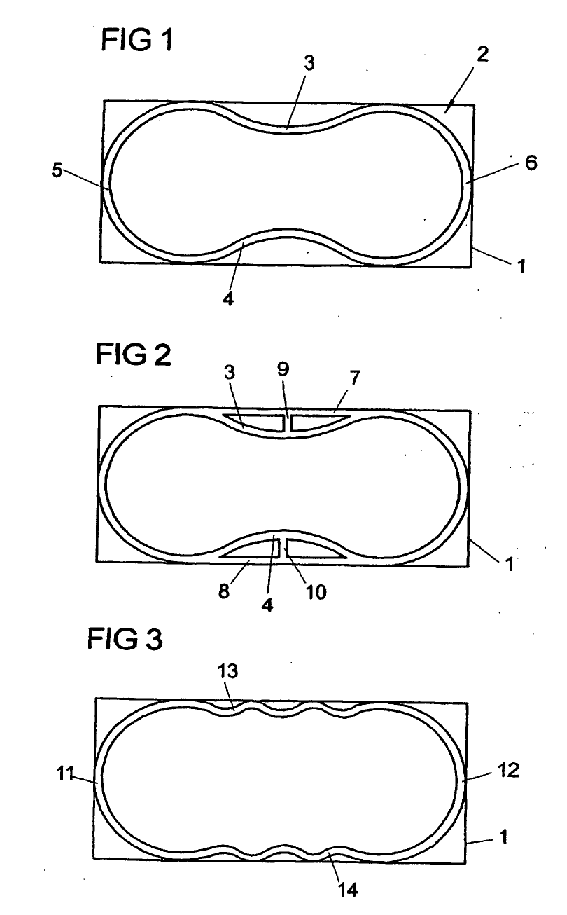

With reference to the figures, the rectangular construction space 1 may be included in the instrument panel for the airbag housing of the front seat passenger airbag. FIG. 1 illustrates an airbag housing 2. The walls of the airbag housing 2 include segments of a circle. The airbag housing 2 includes two longitudinal walls 3, 4 that include segments of a circle and may be curved inward. The longitudinal walls may be connected to end walls 5, 6 that include a semicircular configuration and may be curved outward. Therefore, deformation of the airbag housing may be limited. Additionally, the airbag housing 2 may require less material than that of conventional airbag housings.

FIG. 2 shows an airbag housing according to an exemplary embodiment. The airbag housing, when viewed from above, may include the same shape as the airbag housing 2 of FIG. 1. A stiffening method 7, 8 may be arranged in the region of the longitudinal walls 3, 4 opposite the airbag housing. Between each longitudinal wall 3, 4 and the assigned stiffening apparatus 7, 8, a stiffening rib 9 or 10 may be included in the center of the longitudinal wall. Additionally, the stiffening method may require less material than that of a conventional airbag housing.

Referring to FIG. 3, end walls 11, 12 may be designed as outwardly curved semicircles similar to FIGS. 1 and 2. Longitudinal walls 13, 14 may be included. The longitudinal walls 13, 14 may be curved inward and outward in an alternating manner.

The disclosed airbag housing is to be used with an airbag and inflator in an arrangement such as, for example, U.S. Pat. No. 6,203,056 incorporated by reference herein.

The German priority patent application 20 2006 000 300.2, filed Jan. 5, 2006 including the specification, drawings, claims and abstract, is incorporated herein by reference in its entirety.

Given the disclosure of the application, one versed in the art would appreciate that there may be other embodiments and modifications within the scope and spirit of the application. Accordingly, all modifications attainable by one versed in the art from the present disclosure within the scope and spirit of the present application are to be included as further embodiments of the present application. The scope of the present application is to be defined as set forth in the following claims.

What is claimed is:

1. An airbag housing for a front seat passenger airbag module, the airbag housing comprising:
high side walls having a curved profile when viewed from above.

2. The airbag housing as claimed in claim 1, wherein the side walls comprise two inwardly curved longitudinal walls and two outwardly curved end walls.

3. The airbag housing as claimed in claim 1, wherein the side walls are form segments of a circle.

4. The airbag housing as claimed in claim 1, wherein at least sections of the side walls are curved inward and outward in an alternating manner.

5. The airbag housing as claimed claim 1, wherein the longitudinal walls comprise a stiffening apparatus on an outside portion.

6. The airbag housing as claimed in claim 4, further comprising:
a stiffening apparatus running in a longitudinal direction of the airbag housing on each side wall; and
at least one stiffening rib arranged between each stiffening apparatus and side wall.

7. The airbag housing as claimed in claim 6, wherein a single stiffening rib is arranged in the center of each side wall.
